(19) United States
(12) Patent Application Publication
(10) Pub. No.: US 2009/0084306 A1
(43) Pub. Date: Apr. 2, 2009

(54) Foldable traffic safety marker

(76) Inventor: Donald F. Noonan, II, Greenville, SC (US)

Correspondence Address: J. BENNETT MULLINAX, LLC, P. O. BOX 26029, GREENVILLE, SC, 29616-1029, US

(21) Appl. No.: 11/906,226

(22) Filed: Oct. 1, 2007

(51) Int. Cl. G09F 13/16

(52) U.S. Cl. 116/63 T

(57) ABSTRACT

A traffic safety marker is provided. The marker has a first triangle and a second triangle in pivoting engagement. The first triangle and second triangle are capable of being pivoted with respect to one another so as to be oriented into a storage position. The first triangle and second triangle are capable of being pivoted with respect to one another so as to be oriented into a use position. Also included is a spring that is configured to urge the first triangle and second triangle to pivot with respect to one another.

### FIELD OF THE INVENTION

The present invention relates generally to a foldable traffic safety marker that can be used to alert motorists to the presence of a disabled vehicle, accident scene, or construction site. More particularly, the present application involves a foldable traffic safety marker that has two portions arranged generally as triangles that can be folded onto one another into a storage position and then subsequently unfolded into a warning position in order to form a pair of triangles that provide for increased visibility in alerting approaching motorists.

### BACKGROUND

Motorists often find themselves stopped on the side of the road due to a mechanical break down of the vehicle. For example, should the vehicle suffer a flat tire the motorist will spend several minutes working on the shoulder of the road in order to install his or her spare. The motorist and passengers in the disabled vehicle are at risk of being hit by passing cars and trucks. Although the motorist may activate blinking warning lights on the vehicle to warn approaching cars and trucks, these are sometimes hard to notice. It is known to display safety markers, such as cones and triangles, behind a disabled vehicle in order to alert other motorists on the highway of the disabled vehicle.

Triangular safety markers are typically bright orange or red in color in order to more easily draw the eye of an approaching motorist during daylight hours. Also, these types of markers may include a reflective material that functions to increase visibility at night when illuminated by the headlights of an approaching vehicle. However, should the triangular safety marker be turned out of its desired orientation its visibility will be diminished. Wind brought about by passing vehicles may function to turn a triangular safety marker so that its face is not directed towards approaching vehicles thus reducing its effectiveness as a warning device. Further, wind forces may be capable of knocking over the triangular warning device thus completely eliminating its functionality.

It is known to provide a triangular safety marker with a base that is perpendicular to the face of the marker in order to increase its stability during use. Some triangular safety markers feature a foldable base so that the safety marker can be reduced in size after use in order to allow for easier storage in the vehicle. Although suitable for their intended purpose, triangular safety markers may move or turn from their desired position thus limiting their effectiveness in warning approaching motorists. As such, there remains room for variation and improvement within the art.

### SUMMARY

Various features and advantages of the invention will be set forth in part in the following description, or may be obvious from the description, or may be learned from practice of the invention.

One aspect of one exemplary embodiment is provided in a traffic safety marker that has a first portion with a light reflecting member capable of reflecting light in order to increase visibility of the first portion. The first portion has a base that is weighted so that the bottom of the first portion is heavier than the top of the first portion. A second portion is also provided and has a light reflecting member capable of reflecting light in order to increase visibility of the second portion. The second portion has a base that is weighted so that the bottom of the second portion is heavier than the top of the second portion. Also included is a pivot configured for placing the first portion and the second portion in pivoting engagement with one another so that they are capable of pivoting with respect to one another. The pivot is located with respect to the first portion so as to divide the first portion into a first half and a second half. The pivot is located with respect to the second portion so as to divide the second portion into a first half and a second half.

Also provided in accordance with another aspect of one exemplary embodiment is a traffic safety marker as immediately discussed in which the first portion has a left leg and a right leg. The base, left leg and the right leg of the first portion are arranged in the shape of a triangle. The pivot is located between the left leg and the right leg of the first portion. Additionally, the pivot is located half way along the base of the first portion. In a similar manner, the second portion has a left leg and a right leg. The base, left leg and the right leg of the second portion are arranged in the shape of a triangle. The pivot is located between the left leg and the right leg of the second portion. The pivot is located half way along the base of the second portion.

Another aspect of another exemplary embodiment is provided in a traffic safety marker as discussed above in which the base of the first portion has a weighted member. The weighted member functions to cause the bottom of the first portion to be heavier than the top of the first portion in order to increase stability of the first portion when resting on a surface. The base of the second portion has a weighted member in order to cause the bottom of the second portion to be heavier than the top of the second portion in order to increase stability of the second portion when resting on the surface.

One aspect of one exemplary embodiment is provided in a traffic safety marker as previously mentioned that further includes projections extending from the bottom of the first portion and the second portion. The projections are configured for providing resistance to movement of the first portion and second portion when they are placed on a surface through being at least partially disposed within naturally occurring depressions in the surface.

Another aspect of an additional exemplary embodiment is provided in a traffic safety marker as previously mentioned that further includes a spring. The spring is configured to urge the first portion and second portion away from one another about the pivot.

One aspect of one exemplary embodiment is provided in a traffic safety marker that has a first triangle and a second triangle in pivoting engagement. The first triangle and second triangle are capable of being pivoted with respect to one another so as to be oriented into a storage position. The first triangle and second triangle are capable of being pivoted with respect to one another so as to be oriented into a use position. Also included is a spring that is configured to urge the first triangle and second triangle to pivot with respect to one another.

Another aspect of an additional exemplary embodiment resides in a traffic safety marker as immediately discussed in which the bottom of the first triangle has a weighted member. The weighted member causes the bottom of the first triangle to be heavier than the top of the first triangle in order to increase stability of the first triangle when resting on a surface. The bottom of the second triangle has a weighted member so that the bottom of the second triangle is heavier than the top of the second triangle in order to increase stability of the second triangle when resting on the surface.

Another aspect of a further exemplary embodiment is found in a traffic safety marker as previously mentioned that further includes projections that extend from the bottom of the first triangle and second triangle. The projections are configured for providing resistance to movement of the first triangle and second triangle when the first triangle and second triangle are placed on a surface through being at least partially disposed within naturally occurring depressions in the surface.

An additional aspect of another exemplary embodiment is provided in a traffic safety marker that has a first triangle that with a base, a left leg and a right leg that define a triangular central aperture. The base, left leg and right leg of the first triangle have a light reflecting member capable of reflecting light in order to increase visibility of the first triangle. A second triangle is present and has a base, a left leg and a right leg that define a triangular central aperture. The base, left leg and right leg of the second triangle have a light reflecting member capable of reflecting light in order to increase visibility of the second triangle. A first pin is located midway along the length of the base of the first triangle and midway along the length of the base of the second triangle. A second pin is located between the left leg and right leg of the first triangle. The second pin is located between the left leg and the right leg of the second triangle. The first pin and second pin are coaxial with respect to one another. The first triangle and second triangle are capable of pivoting with respect to one another about the first pin and second pin. The first triangle and second triangle are capable of being oriented into a storage position in which a first side of a half of the first triangle is located adjacent a first side of a half of the second triangle. The first triangle and second triangle are capable of being oriented into a use position in which the first side of the half of the first triangle is oriented at a ninety degree angle to the first side of the half of the second triangle. Also present is a first spring located proximate to the first pin. The first spring urges the first triangle and the second triangle to the use position. A second spring is located proximate to the second pin. The second spring urges the first triangle and the second triangle to the use position.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a traffic safety marker oriented in a use position in accordance with one exemplary embodiment.

FIG. 2 is a front view of the traffic safety marker of FIG. 1. shown placed onto a surface.

FIG. 3 is a top view of the traffic safety marker of FIG. 1.

FIG. 4 is a perspective view of the traffic safety marker of FIG. 1 oriented in a storage position.

FIG. 5 is a front view of the traffic safety marker of FIG. 4.

FIG. 6 is a top view of the traffic safety marker of FIG. 4.

FIG. 7 is a perspective view of a traffic safety marker capable of supporting a reflective cylinder in accordance with one exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 116-150, 170-190, and 153-162. Further, all limits mentioned herein include all other limits included in the mentioned limits. For instance, a limit of up to 7 also includes a limit of up to 5, up to 3, and up to 4.5.

The present invention provides for a traffic safety marker 10 that is capable of being used to alert passing motorists of a disabled vehicle, accident scene, construction site or other potentially hazardous driving obstacle. The traffic safety marker 10 may include a first portion 12 and a second portion 14 that may both be in the shape of a triangle. The portions 12 and 14 can be arranged in a use orientation and placed onto a surface 76 so that they display visible triangles to passing motorists from different angles. Once the traffic safety marker 10 is no longer needed, the first and second portions 12 and 14 can be reoriented into a storage position for easier storage in a vehicle. The first and second portions 12 and 14 can be configured in pivoting engagement with one another so that they can be oriented between the use position and the storage position.

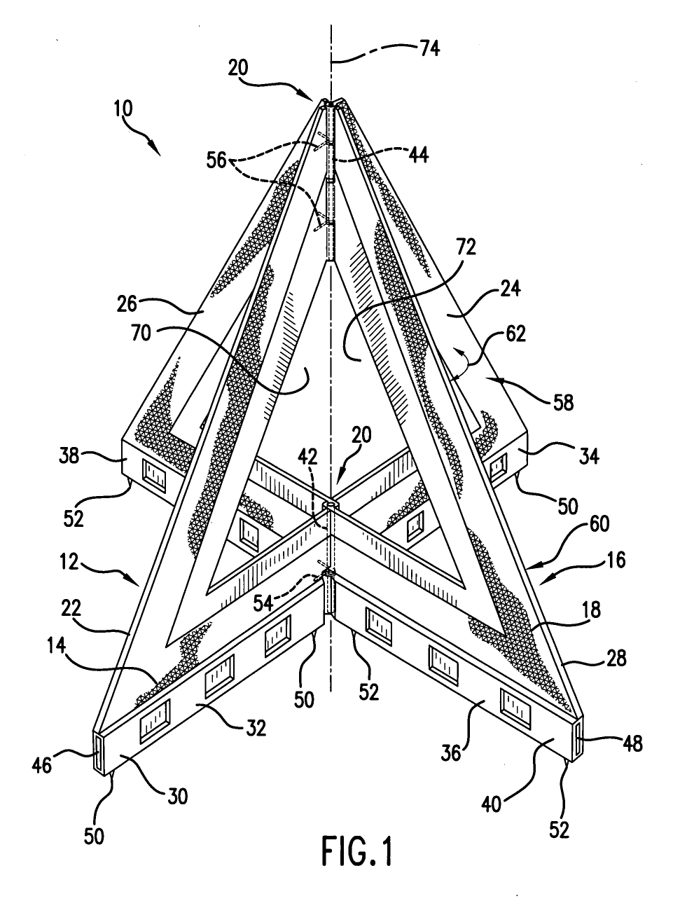

One exemplary embodiment of the traffic safety marker 10 is shown in FIGS. 1-3. The traffic safety marker 10 includes a first portion 12 and a second portion 16 that are in the shape of triangles. However, it is to be understood that the first portion 12 and second portion 16 can be variously configured in accordance with other exemplary embodiments and need not be in the shape of triangles. For example, the portions 12 and 16 can be square shaped, oval shaped, star shaped, rectangular shaped, cylindrical shaped, or circular shaped in other various embodiments. Further, although shown as being similarly shaped, the first portion 12 and second portion 16 can be shaped differently from one another in other arrangements of the traffic safety marker 10.

The first portion 12 is configured as a triangle so that it has a base 30, a left leg 32 and a right leg 40. The base 30, left leg 32 and right leg 40 define a central opening 70 that is triangular in shape. However, it is to be understood that the base 30, left leg 32 and right leg 40 need not define a central opening 70 in other exemplary embodiments. Further, the central opening 70 can be provided in other than a triangular shape. The first portion 12 includes a light reflecting member 14 that is disposed onto at least a portion of the base 30, left leg 32 and right leg 40. The light reflecting member 14 can be a red reflective component that includes spherical beads and/or cubed prism retroreflective elements for use in reflecting directed light to increase visibility of the first portion 12 at night. Inside of the red reflective component, an orange fluorescent section by be disposed to aid in increasing visibility of the first portion 12 during daylight hours. As such, the first portion 12 can be provided in a manner that conforms with motor vehicle and automotive engineering standards for advance warning devices. However, it is to be understood that the traffic safety marker 10 may be variously configured in accordance with other exemplary embodiments and that the disclosed description is by way of example of only one or more embodiments.

The first portion 12 thus in and of itself may be sufficiently designed to function as a traffic safety marker to alert approaching motorists of a disabled vehicle or some other roadway item. The second portion 16 may be provided in order to make the traffic safety marker 10 easier to view by the passing motorist so as to increase its overall effectiveness. The second portion 16 may include a base 36, a left leg 38 and a right leg 40 that are arranged with respect to one another so as to form a triangle. The base 36, left leg 38 and right leg 40 can define a central opening 72 that is also in the shape of a triangle. However, as previously discussed with respect to central opening 70, the central opening 72 need not be triangular in shape or even be provided at all in accordance with other exemplary embodiments. The second portion 16 can carry a light reflecting member 18. The light reflecting member 18 may be arranged in a manner similar to the light reflecting member 14. In this regard, red reflective components are located on the base 36 and legs 38, 40 and surround an orange fluorescent section that is proximate to the central opening 72. Although shown and described as being similar, it is to be understood that the light reflecting members 14 and 18 may be arranged in different manners to one another and need not be provided at all in accordance with various exemplary embodiments.

The first portion 12 has a base 30 that can include a weighted member 46. The weighted member 46 is not covered with the light reflecting member 14. However, in other embodiments the light reflecting member 14 may be arranged so as to cover the weighted member 46. The weighted member 46 can be made of a variety of materials and may be provided in various configurations. For example, the weighted member 46 can be a steel strip slid into an open pocket formed in base 30 in accordance with one embodiment. The weighted member 46 functions to increase the weight of the base 30 so that the bottom of the first portion 12 is heavier than the top of the first portion 12 in order to prevent the first portion 12 from falling over when displayed as a warning device. The first portion 12 may thus be made so as to conform to motor vehicle and automotive engineering standards regarding stability and tip prevention. Provision of a bottom heavy first portion 12 may cause the first portion 12 to resist tipping due to forces brought about by wind. Further, the presence of the central opening 70 may also act to reduce wind forces on the first portion 12 as wind will blow through the central opening 70 and thus not act to tip the first portion 12. Although described as being a separate component that is incorporated into the first portion 12, the weighted member 46 may be integrally formed with other parts of the first portion 12 in other embodiments. Further, the base 30 may simply be made heavier than the legs 32 and 34, through the use of more material or a different denser material, to achieve the same bottom heavy effect with the incorporation of a weighted member 46 therein.

The second portion 16 can include a weighted member 48 that can be arranged in a similar fashion to the weighted member 46 of the first portion 12. As such, a repeat of this information is not necessary. Further, as previously stated with respect to the central opening 70, the central opening 72 may be provided in order to allow wind to flow through the second portion 16 to discourage tipping of the second portion 16.

The weighted members 46 and 48 cause the width of the bases 30 and 36 to be greater than the widths of their corresponding legs 32, 34 and 38, 40. However, it is to be understood that the first portion 12 can be arranged so that the base 30, left leg 32 and right leg 34 all have a width that is the same length. In a similar manner, the widths of the base 36, left leg 38 and right leg 40 may all be of the same size in the second portion 16 in other versions of the traffic safety marker 10.

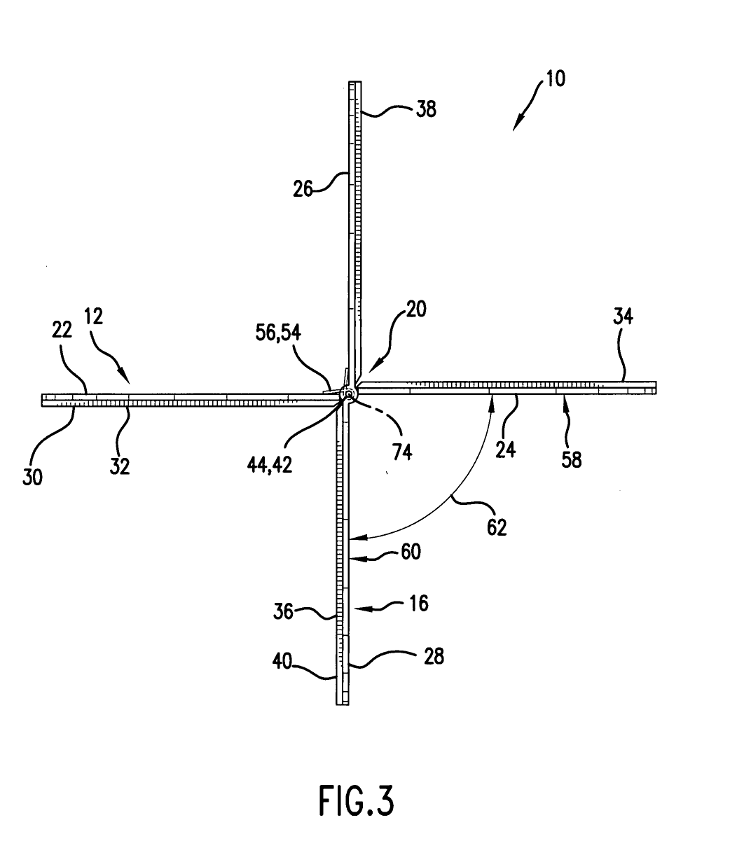

The first portion 12 and second portion 16 can be thus arranged with respect to one another in the use position so as to be essentially at a ninety degree angle to one another. This orientation may be more easily seen with reference to FIG. 3. Such an orientation of the bases 30 and 36 provides a secure footprint to the traffic safety marker 10 that is resistive to tipping. Also, the ninety degree orientation of the first and second portions 12 and 16 allows these portions 12, 16 to be viewed at different angles by approaching motorists thus increasing the effectiveness of the traffic safety marker 10.

Although described as being oriented at ninety degrees to one another in the use position, it is to be understood that the portions 12 and 16 can be arranged at various angles in the use position. The second half 24 of the first portion 12 has a first side 58, and the second half 28 of the second portion 16 has a first side 60. The first sides 58 and 60 are shown positioned at an angle 62 that is ninety degrees in FIG. 3. The angle 62 can be seventy degrees with respect to one another when in the use position in accordance with another exemplary embodiment. In other embodiments, the angle 62 can be forty five degrees when in the use position. In still further exemplary embodiments, the first portion 12 and second portion 16 can be oriented at an angle 62 from thirty to ninety degrees.

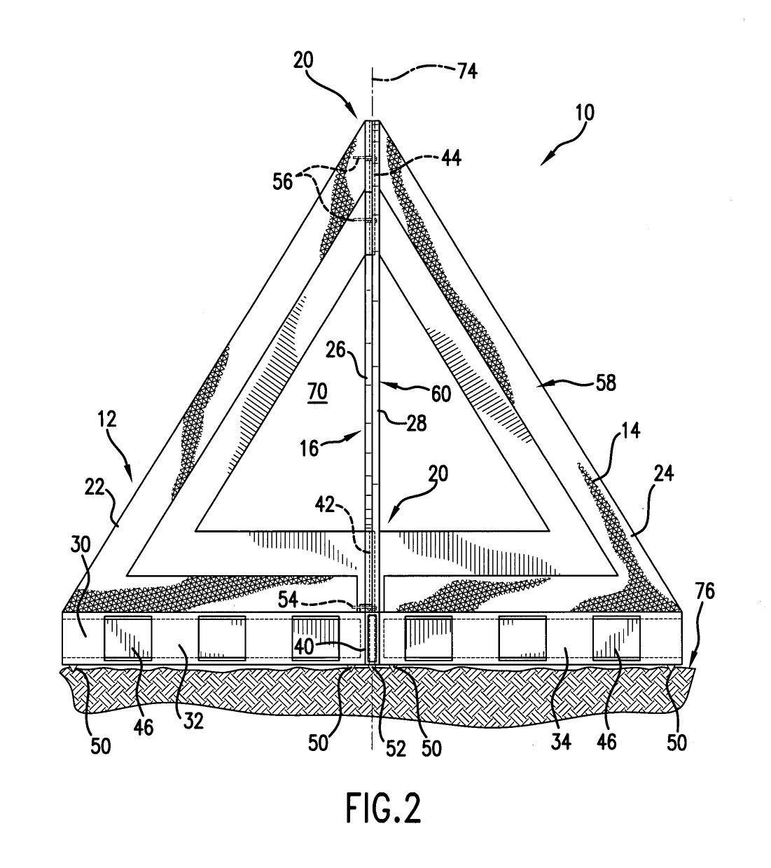

The first portion 12 can include projections 50 that may extend from the lower surface of base 30. In a similar manner, projections 52 can extend from the lower surface of the base 36 of the second portion 16. The projections 50 and 52 can be included in order to allow the portions 12 and 16 to better grip a surface 76 that may be, for instance, an asphalt surface. FIG. 2 is a front view of the traffic safety marker 10 of FIG. 1 that shows the projections 50 and 52 disposed within depressions of the asphalt surface 76 onto which the traffic safety marker 10 rests. At least a portion of the projections 50 and 52 can be disposed within naturally occurring depressions in asphalt or concrete roadway or shoulder or the like. The projections 50 and 52 can be arranged so as to be capable of being inserted into depressions or other naturally occurring irregularities in the surface 76. In this regard, the projections 50 and 52 function to hold the traffic safety marker 10 at the spot it is placed, hence resisting movement or sliding on the surface 76 by wind or other forces. The projections 50 and 52 can be provided in any number, size or configuration. Also, additional exemplary embodiments exist in which the projections 50 and 52 are not present.

The first portion 12 and second portion 16 can be placed into pivoting engagement with one another so that they can be oriented into the use position. The pivoting engagement is effected by a pivot 20 as shown in FIG. 1. The pivot 20 defines a pivoting axis 74 about which the first portion 12 and second portion 16 may pivot with respect to one another. The pivoting axis 74 may be oriented in the vertical direction. The pivot 20 is arranged with respect to the first portion 12 so as to divide the first portion 12 into a first half 22 and a second half 24. The first half 22 includes the left leg 32, and the second half 24 includes the right leg 34. The base 30 is divided along its length at its midpoint by the pivot 20 so that half of the base 30 is in the first half 22 and the other half of the base 30 is in the second half 24. The surfaces of the first half 22 and second half 24 need not lie in the same plane as one another. However, in accordance with other embodiments, the first portion 12 can be arranged with respect to the pivot 20 so that the first half 22 and second half 24 have surfaces that lie in the same plane as one another.

The pivot 20 also divides the second portion 16 into a first half 26 and a second half 28. The first half 26 includes the left leg 38, and the second half 28 of the second portion 16 includes the right leg 40. The base 36 of the second half 28 is split at its midpoint so that half of the base 36 is included in the first half 26 and the other half of the base 36 is in the second half 28. The surfaces of the first half 26 and the second half 28 may or may not lie in the same plane as one another in accordance with various exemplary embodiments.

Pivot 20 is made up of a first pin 42 and a second pin 44. The pins 42 and 44 are coaxial with one another and are separated some distance along the pivoting axis 74. The distance of separation of pins 42 and 44 is essentially the height of the central openings 70 and 72. The first pin 42 is located proximate the bases 30 and 36 of the first portion 12 and the second portion 16. The second pin 44 is located proximate the legs 32, 34, 38 and 40 of the portions 12 and 16. The portions 12 and 16 are thus placed into pivoting engagement with one another through the use of pins 42 and 44 that allow the portions 12 and 16 to pivot thereabout. Although shown as being constructed through the use of pins 42 and 44, the pivot 20 can be variously formed in accordance with other exemplary embodiments. For example, the pivot 20 can be integrally formed with the portions 12 and 16. In this arrangement, one of the portions 12 and 16 can have a rounded area located on one end that is engaged by a complimentary rounded member of the other portion 12 or 16. Such an arrangement would allow the portions 12 and 16 to rotate with respect to one another. In another arrangement a piano hinge can be used as the hinge 20 to allow the first portion 12 and second portion 16 to pivot. As such, it is to be understood that the configuration of the pivot 20 as shown and described is only but one exemplary arrangement and that others are possible.

A first spring 54 is provided and is incorporated into the traffic safety marker 10 at the first pin 42. Similarly, a second spring 56 is located at the second pin 44. The first spring 54 and second spring 56 function to urge the first portion 12 and second portion 16 into the use position. In this regard, the springs 54 and 56 act to push the first portion 12 and second portion 16 away from one another. As such, once the portions 12 and 16 are desirably oriented into the use position and placed onto the surface 76 for display to passing motorists, the springs 54 and 56 act to hold the device in this desired position.

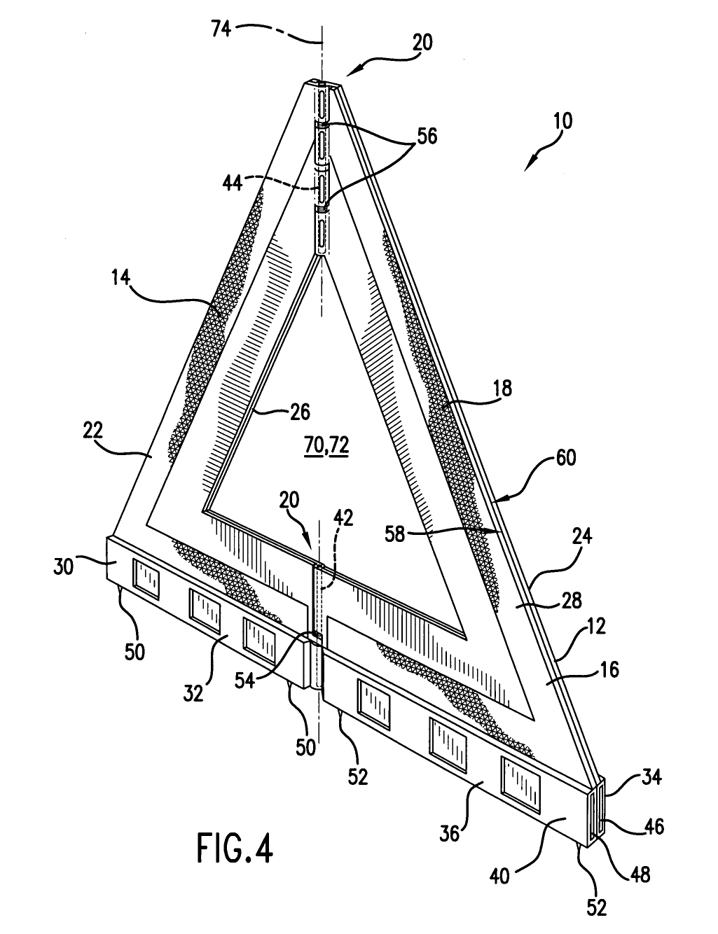

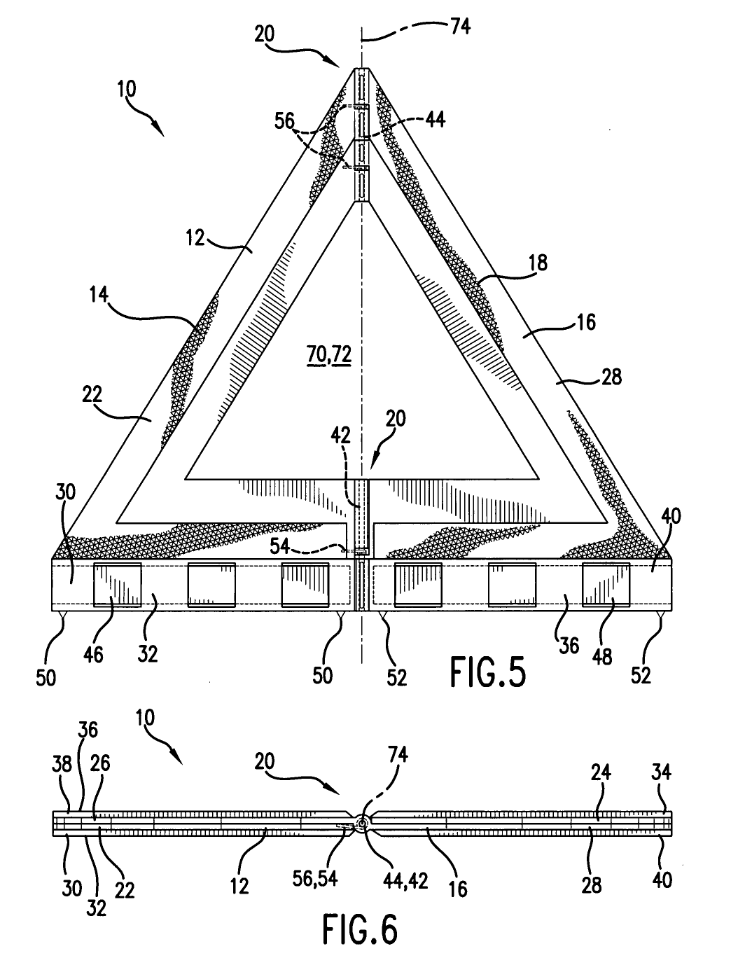

Once the emergency has ceased or the disabled vehicle has been attended to, the traffic safety marker 10 can be removed from the surface 76 and stored back into the owner's vehicle for future use. In this regard, the orientation of the first portion 12 and second portion 16 in the use position may take up an undesirable amount of space in the trunk, trailer or cab of the owner's vehicle. The traffic safety marker 10 can thus be oriented into a storage position to save space at times when the traffic safety marker 10 is not needed. FIGS. 4-6 show various views of the same traffic safety marker 10 as in FIGS. 1-3 only oriented from the use position into the storage position. Here, the first portion 12 and/or second portion 16 can be pivoted about the pivot 20 into the illustrated configuration. Doing so essentially causes the angle 62 as previously mentioned to be zero degrees. However, the angle 62 may be up to thirty degrees when the first and second portions 12 and 16 are placed into the storage position in accordance with other exemplary embodiments.

Reorientation of the first and second portions 12 and 16 into the storage position may cause the first side 58 to contact the second side 60. In other instances, the portions 12 and 16 can be arranged so that the angle 62 is substantially zero yet the sides 58 and 60 of the two portions 12 and 16 do not touch one another. The weight of the first portion 12 and/or the second portion 16 may be sufficient such that the spring forces of the first and second springs 54 and 56 are not enough to overcome the weight of the portions 12, 16 to force the traffic safety marker 10 back into the use position. In this regard, the user can pick up the traffic safety marker 10, reorient the first and second portions 12 and 16 into the storage position and then lay the traffic safety marker 10 down onto a surface such that a side of one of the portions 12, 16 touches the surface. In this orientation, the weight of portion 12 and/or portion 16 will overpower the spring forces from springs 54 and 56 and cause the traffic safety marker 10 to be stored in the desired orientation. When use is again desired, the force from springs 54 and 56 may be great enough to push the portions 12 and 16 into the use position once the traffic safety marker 10 is positioned so that the bases 30 and 36 are on the bottom. Alternatively, the components can be selected so that some amount of force is needed to be imparted by the user to push the portions 12, 16 out of the storage position. It is to be understood that the traffic safety marker 10 can be arranged in a variety of manners such that the spring force of springs 54 and 56 can be of any magnitude. Further embodiments also exist in which the springs 54 and 56 urge the portions 12 and 16 into the storage position instead of into the use position.

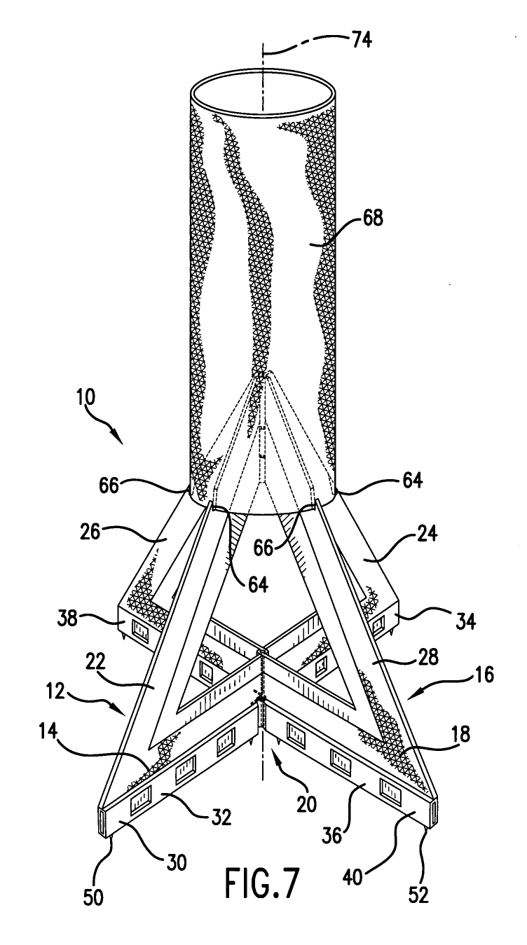

An additional exemplary embodiment of the traffic safety marker 10 is shown in FIG. 7. Here, the first portion 12 defines a pair of slots 64. One of the slots 64 is located in the left leg 32 and the other slot 64 is in the right leg 34. The second portion 16 also defines a pair of slots 66. In a similar manner, left leg 38 includes one of the slots 66, while the right leg 40 has the second slot 66. A reflective cylinder 68, which in some embodiments can be a reflective MYLAR® sheet (E.I. du Pont de Nemours) that is folded into a tube, can be inserted into the slots 64 and 66. The reflective cylinder 68 thus functions to add increased visibility. The reflective cylinder 68 can be arranged so that it complies with applicable motor vehicle and automotive engineering standards to allow for use in a construction zone. In these instances, the first and second portions 12 and 16 function as a base to the reflective cylinder 68 and also function to provide increased visibility.

As described herein, the base 30 of the first portion 12 may include the entire bottom side of the first portion 12 when the first portion is formed as a triangle. In these instances, the base 30 includes makes up the first portion 12 with the exception of the left leg 32 and the right leg 34. However, in accordance with other exemplary embodiments, the base 30 may make up only a portion of the bottom side of the first portion 12 when the first portion 12 is arranged as a triangle. The base 30 can be heavier than other parts of the first portion 12 so that the bottom of the first portion 12 is heavier than the top of the first portion 12 to prevent tipping. In this regard, when the first portion 12 is configured as a triangle the bottom side of the triangle may be heavier than both the left leg 32 and the right leg 34. In other arrangements, the bottom half of the first portion 12 can be heavier than the top half of the first portion 12 measured simply in the vertical direction. In still further embodiments, the bottom of the first portion 12 may be the area vertically below the central opening 70. In other embodiments, when the first portion 12 is arranged as a triangle, the base 30 can include roughly half of the height of the bottom leg of the triangle and the base 30 can be heavier than both the left leg 32, right leg 34 and the bottom leg of the first portion 12 making up the triangle. The base 36, left leg 38 and right leg 40 of the second portion 16 can be arranged in a similar manner as previously described with respect to the first portion 12 and a repeat of this information is not necessary.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A traffic safety marker, comprising:
a first portion that has a light reflecting member capable of reflecting light in order to increase visibility of said first portion, wherein said first portion has a base that is weighted so that the bottom of said first portion is heavier than the top of said first portion;
a second portion that has a light reflecting member capable of reflecting light in order to increase visibility of said second portion, wherein said second portion has a base that is weighted so that the bottom of said second portion is heavier than the top of said second portion; and
a pivot configured for placing said first portion and said second portion in pivoting engagement with one another so that they are capable of pivoting with respect to one another, wherein said pivot is located with respect to said first portion so as to divide said first portion into a first half and a second half, and wherein said pivot is located with respect to said second portion so as to divide said second portion into a first half and a second half.

2. The traffic safety marker as set forth in claim 1, wherein:
said first portion has a left leg and a right leg, wherein said base, said left leg and said right leg of said first portion are arranged in the shape of a triangle, and wherein said pivot is located between said left leg and said right leg of said first portion, and wherein said pivot is located half way along said base of said first portion; and
wherein said second portion has a left leg and a right leg, wherein said base, said left leg and said right leg of said second portion are arranged in the shape of a triangle, and wherein said pivot is located between said left leg and said right leg of said second portion, and wherein said pivot is located half way along said base of said second portion.

3. The traffic safety marker as set forth in claim 1, wherein said pivot is made of two pins, wherein said two pins are arranged so as to be coaxial with one another and separated from one another.

4. The traffic safety marker as set forth in claim 1, wherein said pivot is integrally formed with at least one of said first portion and said second portion.

5. The traffic safety marker as set forth in claim 1, wherein said base of said first portion has a weighted member in order to cause the bottom of said first portion to be heavier than the top of said first portion in order to increase stability of said first portion when resting on a surface, and wherein said base of said second portion has a weighted member in order to cause the bottom of said second portion to be heavier than the top of said second portion in order to increase stability of said second portion when resting on the surface.

6. The traffic safety marker as set forth in claim 1, further comprising projections extending from the bottom of said first portion and said second portion, wherein said projections are configured for providing resistance to movement of said first portion and said second portion when said first portion and said second portion are placed on a surface through being at least partially disposed within naturally occurring depressions in the surface.

7. The traffic safety marker as set forth in claim 1, further comprising a spring configured to urge said first portion and said second portion away from one another about said pivot.

8. The traffic safety marker as set forth in claim 1, wherein said first portion and said second portion are configured for pivoting about said pivot such that a first side of said second half of said first portion is capable of substantially touching a first side of said second half of said second portion, and wherein said first portion and said second portion are configured for pivoting about said pivot such that said first side of said second half of said first portion and said first side of said second half of said second portion are capable of being oriented at an angle of substantially ninety degrees to one another.

9. The traffic safety marker as set forth in claim 1, wherein said first portion defines a pair of slots, and wherein said second portion defines a pair of slots, and wherein said slots of said first portion and said second portion are capable of receiving a reflective cylinder.

10. A traffic safety marker, comprising:
a first triangle;
a second triangle in pivoting engagement with said first triangle, wherein said first triangle and said second triangle are capable of being pivoted with respect to one another so as to be oriented into a storage position, and wherein said first triangle and said second triangle are capable of being pivoted with respect to one another so as to be oriented into a use position; and
a spring that is configured to urge said first triangle and said second triangle to pivot with respect to one another.

11. The traffic safety marker as set forth in claim 10, wherein said first triangle has a light reflecting member to reflect light to increase the visibility of said first triangle, and wherein said second triangle has a light reflecting member to reflect light to increase the visibility of said second triangle.

12. The traffic safety marker as set forth in claim 10, wherein
said first triangle has a base, a left leg and a right leg that define a central opening; and
wherein said second triangle has a base, a left leg and a right leg that define a central opening.

13. The traffic safety marker as set forth in claim 12, wherein:
said base of said first triangle is wider than said left leg of said first triangle, and wherein said base of said first triangle is wider than said right leg of said first triangle; and
wherein said base of said second triangle is wider than said left leg of said second triangle, and wherein said base of said second triangle is wider than said right leg of said second triangle.

14. The traffic safety marker as set forth in claim 10, wherein in the storage position a first side of a half of said first triangle touches a first side of a half of said second triangle, and wherein in the use position said first side of a half of said first triangle and said first side of a half of said second triangle are oriented at a ninety degree angle to one another.

15. The traffic safety marker as set forth in claim 10, wherein said first triangle and said second triangle are placed into pivoting engagement through the use of at least one pin that defines a vertical pivoting axis, wherein the pivoting axis divides said first triangle into a first half and a second half, and wherein the pivoting axis divides said second triangle into a first half and a second half.

16. The traffic safety marker as set forth in claim 10, wherein the bottom of said first triangle has a weighted member so that the bottom of said first triangle is heavier than the top of said first triangle in order to increase stability of said first triangle when resting on a surface, and wherein the bottom of said second triangle has a weighted member so that the bottom of said second triangle is heavier than the top of said second triangle in order to increase stability of said second triangle when resting on the surface.

17. The traffic safety marker as set forth in claim 10, further comprising projections extending from the bottom of said first triangle and said second triangle, wherein said projections are configured for providing resistance to movement of said first triangle and said second triangle when said first triangle and said second triangle are placed on a surface through being at least partially disposed within naturally occurring depressions in the surface.

18. The traffic safety marker as set forth in claim 10, wherein said spring is configured to urge said first triangle and said second triangle so that they are pivoted out of the storage position.

19. The traffic safety marker as set forth in claim 10, wherein said first triangle defines a pair of slots, and wherein said second triangle defines a pair of slots, and wherein said slots of said first triangle and said second triangle are capable of receiving a reflective cylinder.

20. A traffic safety marker, comprising
a first triangle that has a base, a left leg and a right leg that define a triangular central aperture, wherein said base, said left leg and said right leg of said first triangle have a light reflecting member capable of reflecting light in order to increase visibility of said first triangle;
a second triangle that has a base, a left leg and a right leg that define a triangular central aperture, wherein said base, said left leg and said right leg of said second triangle have a light reflecting member capable of reflecting light in order to increase visibility of said second triangle;
a first pin located midway along the length of said base of said first triangle and also located midway along the length of said base of said second triangle;
a second pin located between said left leg and said right leg of said first triangle, and wherein said second pin is located between said left leg and said right leg of said second triangle, wherein said first pin and said second pin are coaxial with respect to one another;
wherein said first triangle and said second triangle are capable of pivoting with respect to one another about said first pin and said second pin, wherein said first triangle and said second triangle are capable of being oriented into a storage position in which a first side of a half of said first triangle is located adjacent a first side of a half of said second triangle, and wherein said first triangle and said second triangle are capable of being oriented into a use position in which said first side of said half of said first triangle is oriented at a ninety degree angle to said first side of said half of said second triangle;
a first spring located proximate to said first pin, wherein said first spring urges said first triangle and said second triangle to the use position; and
a second spring located proximate to said second pin, wherein said second spring urges said first triangle and said second triangle to the use position.
